(19) United States
(12) Patent Application Publication
(10) Pub. No.: US 2023/0156562 A1
(43) Pub. Date: May 18, 2023

(54) METHOD AND APPARATUS FOR PROVIDING USER EQUIPMENT ROUTE SELECTION POLICY INFORMATION FOR PROXIMITY-BASED SERVICES IN 5G SYSTEMS

(71) Applicant: NOKIA TECHNOLOGIES OY, Espoo (FI)

(72) Inventors: Laurent THIEBAUT, Antony (FR); Hannu HIETALAHTI, Kiviniemi (FI)

(73) Assignee: NOKIA TECHNOLOGIES OY, Espoo (FI)

(21) Appl. No.: 17/995,837

(22) PCT Filed: Apr. 9, 2020
(86) PCT No.: PCT/FI2020/050237

§ 371 Date: Oct. 7, 2022

(51) Int. Cl. H04W 40/22; H04W 40/24

(52) U.S. Cl. CPC H04W 40/22; H04W 40/248

(57) ABSTRACT

A network node in a wireless communication system supporting device-to-device (D2D) communication, comprising: at least one processor; and at least one memory including computer program code, wherein the computer program code causes the network node, when executed with the at least one processor, to at least: provide, to a user equipment (UE) in the wireless communication system, a UE route selection policy including a traffic descriptor to be used by the UE for D2D communication, the traffic descriptor including information indicating use for D2D communication.

### FIELD

The subject-matter described herein generally relates to wireless communication systems and more particularly, to wireless communication systems supporting device-to-device (D2D) communication. Yet more particularly, the subject-matter described herein relates to providing and using user equipment (UE) route selection policy information for proximity-based services in 5G systems.

### BACKGROUND

In 5G systems, device-to-device (D2D) communication for performing direct communication between devices using wireless communication may be implemented, and since the D2D communication is operated based on the proximity between user equipments (UEs) or between devices, a D2D communication service may be referred to as a proximity-based service (ProSe). The ProSe is a proximity-based service that uses D2D communication proposed by 3rd generation partnership project (3GPP). In the D2D communication, a service may be used through direct communication between UEs.

Architecture enhancements of 5G systems are needed to support ProSe. The 5G systems shall support, among other, direct discovery of the ProSe-enabled UE by other ProSe-enabled UEs within the same Public Land Mobile Network (PLMN) or different PLMNs, including in coverage and out of coverage, ProSe communication and seamless service continuity when switching user traffic between a Uu path and a PC5 path of the ProSe-enabled UEs, including in coverage and out of coverage, path selection between a PC5 path and a Uu path, or path selection/switching between two PC5 paths, e.g. UE-to-Network relay or UE-to-UE relay path selection/switching, the service authorization and provisioning of the ProSe-enabled UEs, UE-to-Network relay functionality, and UE-to-UE relay functionality. Regarding 5G systems architecture enhancements and 3GPP study on ProSe reference is made to TR 23.752 (January 2020 Version), which is incorporated herein by reference in its entirety.

In the UE-to-Network relay functionally, a UE that can connect to the 5G systems based network relays traffic towards/from the 5G systems on behalf of remote UE that cannot itself access to the 5G systems because, for example, it is outside of radio coverage of the NG RAN/base stations of the 5G systems network. Such UE-to-Network relays are especially useful for usage of 5G systems for public safety devices. However, the 5G systems architecture enhancements pose problems for setting up UE-to-Network relay.

### SUMMARY

According to an aspect, there may be provided a network node in a wireless communication system supporting device-to-device (D2D) communication, comprising at least one processor and at least one memory including computer program code. The computer program code causes the network node, when executed with the at least one processor, to at least provide, to a user equipment (UE) in the wireless communication system, a UE route selection policy including a traffic descriptor to be used by the UE for D2D communication, the traffic descriptor including information indicating use for D2D communication.

In some embodiments of the network node, the traffic descriptor may comprise connection capabilities information indicating a capability of a connection to be used. The connection capabilities information may comprise a value representing the information indicating the use for D2D communication. In some embodiments, the value indicates a proximity-based service of the wireless communication system as the capability of the connection to be used.

In some embodiments of the network node, the traffic descriptor may comprise tethering capabilities information representing the information indicating use for D2D communication. The tethering capabilities information may comprise one or more values each indicating a tethering method to be used for D2D communication. In some embodiments, the one or more values may comprise a value to indicate a proximity-based service of the wireless communication system as the tethering method and a value to indicate Bluetooth as the tethering method.

In some embodiments of the network node, the UE route selection policy may further include one or more route selection descriptors associated with the traffic descriptor that includes the information indicating the use for relaying D2D communication. Each route selection descriptor may define parameters for setting up a connection to be used by the UE for relaying D2D communication. In some embodiments, the parameters may include one or more of: Single Network Slice Selection Assistance Information (S-NSSAI), Data Network Name (DNN), a path selection rule between direct and indirect proximity-based service communication over a PC5 connection, security credentials, and a parameter for the PC5 connection of a proximity-based service of the wireless communication system.

In some embodiments of the network node, the computer program code may cause the network node, when executed with the at least one processor, to provide the UE route selection policy in response to determining one of the following: the UE has registered to the wireless communication system, the UE roams to another Public Land Mobile Network (PLMN), the UE route selection policy for the UE has changed, the UE requests to provide the UE route selection policy, and a time interval elapsed.

In some embodiments of the network node, the UE may act as a UE-to-Network relay connecting the UE to the wireless communication system and relaying traffic towards/from the wireless communication system on behalf of a remote UE, or the UE may perform tethering for the remote UE. The remote UE may be connected to the UE but cannot access to the wireless communication system.

In some embodiments of the network node, the wireless communication system may be a 5G system and the D2D communication may be a proximity-based service.

According to another aspect, there may be provided a user equipment (UE) in a wireless communication system supporting device-to-device (D2D) communication, comprising at least one processor and at least one memory including computer program code. The computer program code causes the UE, when executed with the at least one processor, to at least receive, from a network node in the wireless communication system, or store in the at least one memory a UE route selection policy including a traffic descriptor to be used by the UE for D2D communication, the traffic descriptor including information indicating use for D2D communication.

In some embodiments of the UE, the traffic descriptor may comprise connection capabilities information indicating a capability of a connection to be used. The connection capabilities information may comprise a value representing the information indicating the use for D2D communication. In some embodiments, the value may indicate a proximity-based service of the wireless communication system as the capability of the connection to be used.

In some embodiments of the UE, the traffic descriptor may comprise tethering capabilities information representing the information indicating use for D2D communication. The tethering capabilities information may comprise one or more values each indicating a tethering method to be used for D2D communication. In some embodiments, the one or more values may comprise a value to indicate a proximity-based service of the wireless communication system as the tethering method and a value to indicate Bluetooth as the tethering method.

In some embodiments of the UE, the UE route selection policy may further include one or more route selection descriptors associated with the traffic descriptor that includes the information indicating the use for relaying D2D communication. Each route selection descriptor may define parameters for setting up a connection to be used by the UE for relaying D2D communication. In some embodiments, the parameters may include one or more of: Single Network Slice Selection Assistance Information (S-NSSAI), Data Network Name (DNN), a path selection rule between direct and indirect proximity-based service communication over a PC5 connection, security credentials, and a parameter for the PC5 connection of a proximity-based service of the wireless communication system.

In some embodiments of the UE, the computer program code may further cause the UE, when executed with the at least one processor, to match a request for D2D or tethering with the information indicating use for D2D communication to determine whether to select the UE route selection policy.

In some embodiments of the UE, the UE may act as a UE-to-Network relay connecting the UE to the wireless communication system and relaying traffic towards/from the wireless communication system on behalf of a remote UE, or the UE may perform tethering for the remote UE. The remote UE may be connected to the UE but cannot access to the wireless communication system.

In some embodiments of the UE, the wireless communication system may be a 5G system and the D2D communication may be a proximity-based service.

According to another aspect, there may be provided a method in a network node of a wireless communication system supporting device-to-device (D2D) communication. The method comprises providing, to a user equipment (UE) in the wireless communication system, a UE route selection policy including a traffic descriptor to be used by the UE for D2D communication. The traffic descriptor includes information indicating use for D2D communication.

According to another aspect, there may be provided a method in a user equipment (UE) of a wireless communication system supporting device-to-device (D2D) communication. The method comprises receiving, from a network node in the wireless communication system, or store in at least one memory of the UE, a UE route selection policy including a traffic descriptor to be used by the UE for D2D communication, the traffic descriptor including information indicating use for D2D communication.

In some embodiments of the method in the network node, the UE route selection policy is provided in response to determining one of the following: the UE has registered to the wireless communication system, the UE roams to another Public Land Mobile Network (PLMN), the UE route selection policy for the UE has changed, the UE requests to provide the UE route selection policy, and a time interval elapsed.

In some embodiments of the method in the UE, the method may further comprise matching a request for D2D or tethering with the information indicating use for D2D communication to determine whether to select the UE route selection policy.

In some embodiments of the methods, the traffic descriptor may comprise connection capabilities information indicating a capability of a connection to be used, the connection capabilities information comprising a value representing the information indicating the use for D2D communication. In some embodiments, the value may indicate a proximity-based service of the wireless communication system as the capability of the connection to be used.

In some embodiments of the methods, the traffic descriptor may comprise tethering capabilities information representing the information indicating use for D2D communication. The tethering capabilities information may comprise one or more values each indicating a tethering method to be used for D2D communication. In some embodiments, the one or more values may comprise a value to indicate a proximity-based service of the wireless communication system as the tethering method and a value to indicate Bluetooth as the tethering method.

In some embodiments of the methods, the UE route selection policy may further include one or more route selection descriptors associated with the traffic descriptor that includes the information indicating the use for relaying D2D communication. Each route selection descriptor may define parameters for setting up a connection to be used by the UE for relaying D2D communication.

In some embodiments of the methods, the parameters may include one or more of: Single Network Slice Selection Assistance Information (S-NSSAI), Data Network Name (DNN), a path selection rule between direct and indirect proximity-based service communication over a PC5 connection, security credentials, and a parameter for the PC5 connection of a proximity-based service of the wireless communication system.

In some embodiments of the methods, the UE may act as a UE-to-Network relay connecting the UE to the wireless communication system and relaying traffic towards/from the wireless communication system on behalf of a remote UE, or the UE may perform tethering for the remote UE. The remote UE may be connected to the UE but cannot access to the wireless communication system.

In some embodiments of the methods, the wireless communication system may be a 5G system and the D2D communication may be a proximity-based service.

According to a further aspect, a computer program product comprises program instructions stored on a computer readable medium to execute steps according to any one of the embodiments of the methods outlined above when said program is executed on a computer.

The above-noted aspects and features may be implemented in systems, apparatuses, methods, articles and/or non-transitory computer-readable media depending on the desired configuration. The subject matter described herein may be implemented in and/or used with a number of different types of devices, including but not limited to cellular phones, tablet computers, wearable computing devices, portable media players, and any of various other computing devices.

This summary is intended to provide a brief overview of some of the aspects and features according to the subject matter described in this document. Accordingly, it will be appreciated that the above-described features are merely examples and should not be construed to narrow the scope of the subject matter described herein in any way. Other features, aspects, and advantages of the subject matter described herein will become apparent from the following detailed description, drawings and claims.

### BRIEF DESCRIPTION OF THE DRAWINGS

A better understanding of the subject matter described herein can be obtained when the following detailed description of various embodiments is considered in conjunction with the following drawings, in which:

FIG. 1 illustrates a simplified wireless communication system according to some embodiments.

FIG. 2 illustrates an exemplary 5G network supporting user equipment route selection policy in accordance with some embodiments.

FIG. 3 illustrates a simplified block diagram of a UE according to some embodiments.

FIG. 4 illustrates a simplified block diagram of a network node in accordance with some embodiments.

FIG. 5 illustrates an exemplary 5G systems architecture enhancement supporting ProSe in accordance with some embodiments.

FIG. 6 illustrates a simplified sequence flow between a UE and the network node for providing or updating a UE route selection policy in accordance with some embodiments.

FIGS. 7A and 7B illustrate flow charts of methods of providing a UE route selection policy according to some embodiments.

### DETAILED DESCRIPTION

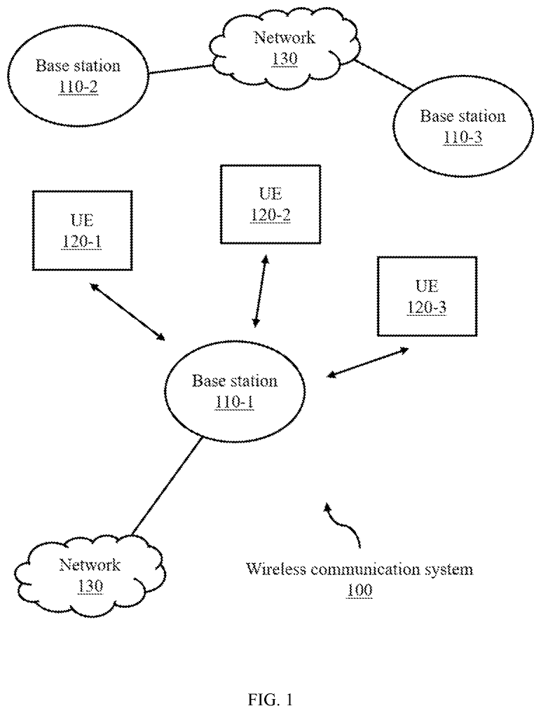

FIG. 1 illustrates a simplified wireless communication system 100, according to some embodiments. It is noted that the system of FIG. 1 is merely one example of a possible system, and that features of the subject matter described herein may be implemented in any of various systems, as desired.

As shown, the wireless communication system 100 includes a base station 110-1 which communicates over a transmission medium with one or more user devices 120. In FIG. 1, only three user devices 120-1, 120-2, and 120-3 are shown, without limitation. Each of the user devices 120-1, 120-2, and 120-3 may be referred to herein as a “user equipment” (UE). Thus, the user devices 120 are referred to as UEs or UE devices.

As used herein, the term “user equipment” may refer to any of various types of computer systems devices which are mobile or portable and which perform wireless communications. Examples of UEs include mobile telephones or smart phones, portable gaming devices, laptops, wearable devices (e.g., smart watch, smart glasses), Personal Digital Assistants (PDAs), portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

The base station (BS) 110-1 may be a base transceiver station (BTS) or cell site (a “cellular base station”), and may include hardware that enables wireless communication with the UEs 120.

As used herein, the term “base station” has the full breadth of its ordinary meaning, and at least includes a wireless communication station installed at a fixed location and used to communicate as part of a wireless telephone system or radio system.

The communication area (or coverage area) of the base station 110 may be referred to as a “cell.” The base station 110 and the UEs 120 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. If the base station 110-1 is implemented in the context of LTE, it may alternately be referred to as an “eNodeB” or “eNB”. If the base station 110-1 is implemented in the context of 5G NR, it may alternately be referred to as “gNodeB” or “gNB”.

As shown, the base station 110-1 may also be equipped to communicate with a network 130 (e.g., a core network of a cellular service provider, a telecommunication network such as a public switched telephone network (PSTN), and/or the Internet, among various possibilities). Thus, the base station 110-1 may facilitate communication between the user devices 120 and/or between the user devices 120 and the network 130. In particular, the cellular base station 110-1 may provide UEs 120 with various telecommunication capabilities, such as voice, SMS and/or data services.

The base station 110-1 and other similar base stations (such as base stations 110-2 and 110-3) operating according to the same or a different cellular communication standard may thus be provided as a network of cells, which may provide continuous or nearly continuous overlapping service to UEs 120 and similar devices over a geographic area via one or more cellular communication standards.

Thus, while base station 110-1 may act as a “serving cell” for UEs 120 as illustrated in FIG. 1, each UE 120 may also be capable of receiving signals from (and possibly within communication range of) one or more other cells (which might be provided by base stations 110 and/or any other base stations), which may be referred to as “neighboring cells”. Such cells may also be capable of facilitating communication between user devices 120 and/or between user devices 120 and the network 130. Such cells may include “macro” cells, “micro” cells, “pico” cells, and/or cells which provide any of various other granularities of service area size. For example, base stations 110-1 and 110-2 illustrated in FIG. 1 might be macro cells, while base station 110-3 might be a micro cell. Other configurations are also possible.

In some embodiments, base station 110-1 may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

The UE 120 may be capable of communicating using multiple wireless communication standards. For example, the UE 120 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 120 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

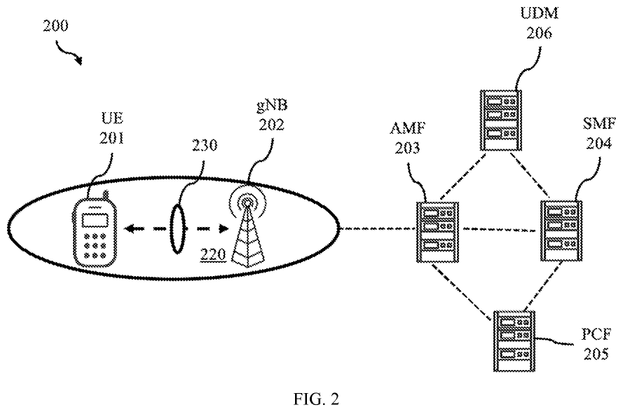

FIG. 2 illustrates an exemplary 5G network 200 supporting a user equipment route selection policy (URSP) in accordance with some embodiments. The 5G new radio (NR) network 200 comprises a user equipment (UE) 201, a base station (gNB) 202, an access and mobility management function (AMF) 203, a session management function (SMF) 204, a policy control function (PCF) 205, and a unified data management (UDM) 206. In the example of FIG. 2, UE 201 and its serving base station (gNB) 202 belong to part of a radio access network (RAN) 220. In Access Stratum (AS) layer, RAN 220 provides radio access for UE 201 via a radio access technology (RAT). In Non-Access Stratum (NAS) layer, AMF 203 communicates with gNB 202 and 5GC 204 for access and mobility management of wireless access devices in 5G network 200. UE 201 may be equipped with a radio frequency (RF) transceiver or multiple RF transceivers for different application services via different RATs/CNs.

The 5G network 200 may be a packet-switched (PS) Internet Protocol (IP) network. This means that the network delivers all data traffic in IP packets, and provides users with Always-On IP Connectivity. When the UE 201 joins the 5G network 200, a Packet Data Network (PDN) address (i.e., the one that can be used on the PDN) is assigned to the UE 201 for its connection to the PDN. In 4G, EPS has defined a Default EPS Bearer to provide the IP Connectivity that is Always-On. In 5G, a Protocol Data Unit (PDU) session establishment procedure is a parallel procedure of a PDN connection procedure in 4G. A PDU session (e.g., 130) defines the association between the UE 201 and the data network that provides a PDU connectivity service. Each PDU session 130 is identified by a PDU session ID, and may include multiple QoS flows and QoS rules.

User equipment policies for a 5G network includes user equipment route selection policy (URSP) and access network discovery and selection policy (ANDSP). The user equipment policies can be delivered from the PCF 205 to UE 201. PCF 205 takes care of network policies to manage network behavior. PCF 205 gets the subscription information from the UDM 206. The PCF 205 interfaces to both the AMF 203 to manage the mobility context and the SMF 204 to manage the session contexts. The PCF 205 also plays a crucial role in providing a scheme for network slicing and roaming. The PCF 205 triggers the URSP which enables the UE 201 to determine how a certain application should be handled in the context of an existing or new Protocol Data Unit (PDU) session. The user equipment policies can also be pre-configured in the UE 201. The pre-configured policy should be applied by the UE 201 only when the UE 201 has not received the same type of policy from the PCF 205.

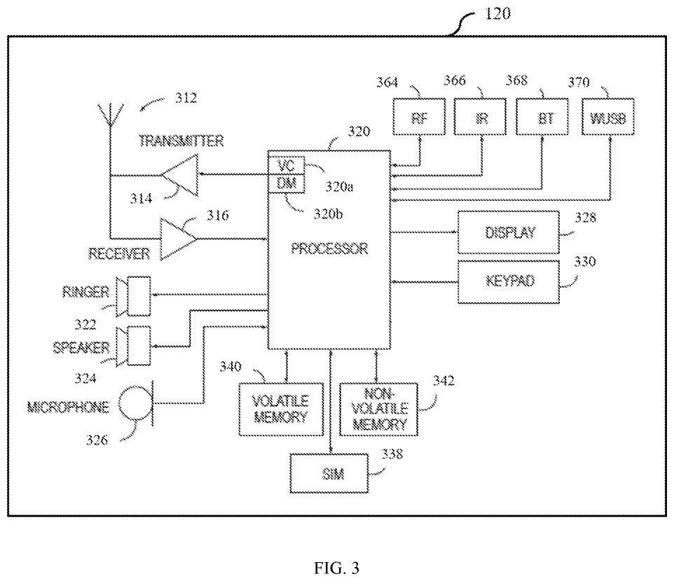

FIG. 3 illustrates a simplified block diagram of a UE 120, according to some embodiments. It is noted that the block diagram of the UE 120 of FIG. 3 is only one example of a possible user device. According to embodiments, UE 120 may be a user device, a mobile device or mobile station, a wireless device or wireless station, a desktop computer or computing device, a mobile computing device (e.g., a laptop, notebook, or portable computing device), a tablet and/or a combination of devices, among other devices.

As shown, the UE 120 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the UE 120.

The UE 120 may include at least one antenna 312 in communication with a transmitter 314 and a receiver 316. Alternatively, transmit and receive antennas may be separate. The UE 120 may also include a processor 320 configured to provide signals to and receive signals from the transmitter 314 and receiver 316, respectively, and to control the functioning of the UE 120. Processor 320 may be configured to control the functioning of the transmitter 314 and receiver 316 by effecting control signaling via electrical leads to the transmitter 314 and receiver 316. Likewise, the processor 320 may be configured to control other elements of the UE 120 by effecting control signaling via electrical leads connecting processor 320 to the other elements, such as a display or a memory. The processor 320 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 3 as a single processor, in some example embodiments the processor 320 may comprise a plurality of processors or processing cores.

The UE 120 may be capable of operating with one or more air interface standards, communication protocols, modulation types, access types, and/or the like. Signals sent and received by the processor 320 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the UE 120 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the UE 120 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the UE 120 may be capable of operating in accordance with 2.5G wireless communication protocols General Packet Radio Service (GPRS), Enhanced Data GSM Environment (EDGE), and/or the like. Further, for example, the UE 120 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The UE 120 may be additionally capable of operating in accordance with 3.9G wireless communication protocols, such as Long Term Evolution (LTE), Evolved Universal Terrestrial Radio Access Network (E-UTRAN), and/or the like. Additionally, for example, the UE 120 may be capable of operating in accordance with 4G wireless communication protocols, such as LTE Advanced, 5G, and/or the like as well as similar wireless communication protocols that may be subsequently developed.

It is understood that the processor 320 may include circuitry for implementing audio/video and logic functions of the UE 120. For example, the processor 320 may comprise a digital signal processor device, a microprocessor device, an analog-to-digital converter, a digital-to-analog converter, and/or the like. Control and signal processing functions of the UE 120 may be allocated between these devices according to their respective capabilities. The processor 320 may additionally comprise an internal voice coder (VC) 320a, an internal data modem (DM) 320b, and/or the like. Further, the processor 320 may include functionality to operate one or more software programs, which may be stored in memory. In general, the processor 320 and stored software instructions may be configured to cause the UE 120 to perform actions. For example, the processor 320 may be capable of operating a connectivity program, such as a web browser. The connectivity program may allow the UE 120 to transmit and receive web content, such as location-based content, according to a protocol, such as wireless application protocol (WAP), hypertext transfer protocol (HTTP), and/or the like.

The UE 120 may also comprise a user interface including, for example, an earphone or speaker 324, a ringer 322, a microphone 326, a display 328, a user input interface, and/or the like, which may be operationally coupled to the processor 320. The display 328 may, as noted above, include a touch sensitive display, where a user may touch and/or gesture to make selections, enter values, and/or the like. The processor 320 may also include user interface circuitry configured to control at least some functions of one or more elements of the user interface, such as the speaker 324, the ringer 322, the microphone 326, the display 328, and/or the like. The processor 320 and/or user interface circuitry comprising the processor 320 may be configured to control one or more functions of one or more elements of the user interface through computer program instructions, for example, software and/or firmware, stored on a memory accessible to the processor 320, for example, volatile memory 340, non-volatile memory 342, and/or the like. The UE 120 may include a battery for powering various circuits related to the mobile terminal, for example, a circuit to provide mechanical vibration as a detectable output. The user input interface may comprise devices allowing the UE 120 to receive data, such as a keypad 330 (which can be a virtual keyboard presented on display 328 or an externally coupled keyboard) and/or other input devices.

As shown in FIG. 3, the UE 120 may also include one or more mechanisms for sharing and/or obtaining data. For example, UE 120 may include a short-range radio frequency (RF) transceiver and/or interrogator 364, so data may be shared with and/or obtained from electronic devices in accordance with RF techniques. The UE 120 may include other short-range transceivers, such as an infrared (IR) transceiver 366, a Bluetooth™ (BT) transceiver 368 operating using Bluetooth™ wireless technology, a wireless universal serial bus (USB) transceiver 370, a Bluetooth™ Low Energy transceiver, a ZigBee transceiver, an ANT transceiver, a cellular device-to-device transceiver, a wireless local area link transceiver, and/or any other short-range radio technology. The UE 120 and, in particular, the short-range transceiver may be capable of transmitting data to and/or receiving data from electronic devices within the proximity of the apparatus, such as within 10 meters, for example. The UE 120 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The UE 120 may comprise memory, such as a subscriber identity module (SIM) 338, a removable user identity module (R-UIM), an eUICC, an UICC, and/or the like, which may store information elements related to a mobile subscriber. In addition to the SIM, the UE 120 may include other removable and/or fixed memory. The UE 120 may include volatile memory 340 and/or non-volatile memory 342. For example, the volatile memory 340 may include Random Access Memory (RAM) including dynamic and/or static RAM, on-chip or off-chip cache memory, and/or the like. The non-volatile memory 342, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 340, the non-volatile memory 342 may include a cache area for temporary storage of data. At least part of the volatile and/or non-volatile memory may be embedded in the processor 320. The memories may store one or more software programs, instructions, pieces of information, data, and/or the like which may be used by the apparatus for performing operations disclosed herein.

The memories may comprise an identifier, such as an International Mobile Equipment Identification (IMEI) code or PEI (Permanent Equipment Identifier as defined in 3GPP TS 23.501), capable of uniquely identifying the Mobile Equipment in UE 120. In the example embodiment, the processor 320 may be configured using computer code stored at memory 340 and/or 342 to cause the processor 320 to perform operations disclosed herein.

Some of the embodiments disclosed herein may be implemented in software, hardware, application logic, or a combination of software, hardware, and application logic. The software, application logic, and/or hardware may reside on the memory 340, the processor 320, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 3, computer-readable medium may comprise a non-transitory computer-readable storage medium that may be any media that can contain or store the instructions for use by or in connection with an instruction execution system, apparatus, or device, such as a computer.

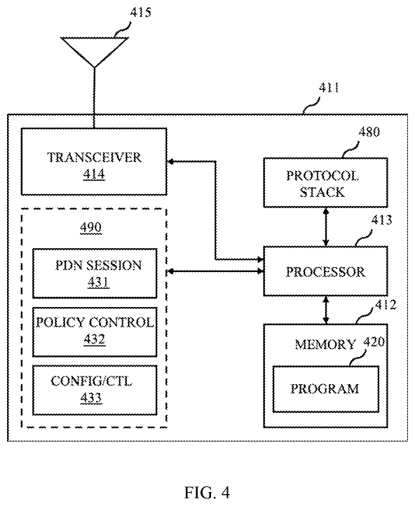

FIG. 4 illustrates a simplified block diagram of a network node 411 in accordance with some embodiments. Network node 411 may be a base station combined with an MME or AMF. Network node 411 has an antenna 415, which transmits and receives radio signals. A radio frequency (RF) transceiver module 414, coupled with the antenna, receives RF signals from antenna 415, converts them to baseband signals and sends them to processor 413. RF transceiver 414 also converts received baseband signals from processor 413, converts them to RF signals, and sends out to antenna 415. Processor 413 processes the received baseband signals and invokes different functional modules to perform features in network node 411. Memory 412 stores program instructions and data 420 to control the operations of the network node 411. In the example of FIG. 4, network node 411 also includes protocol stack 480 and a set of control functional modules and circuit 490. PDU session handling circuit 431 handles PDU session establishment and modification procedures. Policy control module 432 that configures policy rules for UE. Configuration and control circuit 433 provides different parameters to configure and control UE of related functionalities including mobility management and session management. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

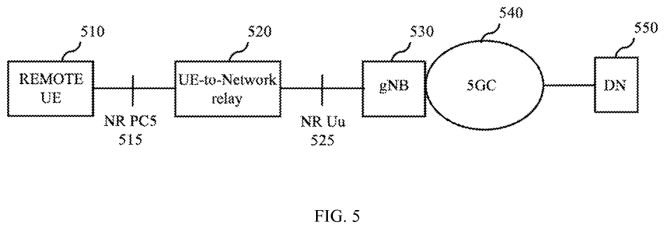

FIG. 5 illustrates an exemplary 5G systems architecture enhancement supporting ProSe in accordance with some embodiments.

The remote UE 510 which cannot access the 5G core network 540 is connected to the UE 520 acting as UE-to-Network relay via NR PC5 connection 515. The UE 520 is connected to the base station (gNB) 530 via NR Uu connection 525 and can access the 5G core network 540. The UE 520 acting as the UE-to-Network relay relays traffic towards/from the 5G core network 540 and/or data network (DN) 550 on behalf of the remote UE 510. In some embodiments, the UE 520 may perform tethering for the remote UE 510.

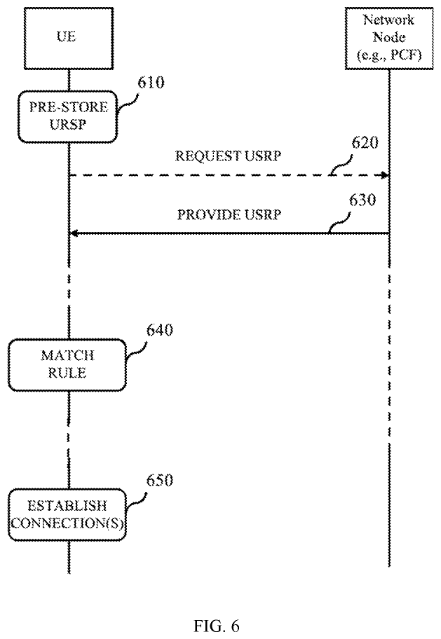

FIG. 6 illustrates a simplified sequence flow between a UE and the network node for providing or updating a UE route selection policy in accordance with an embodiment. The UE may be the UE 120 shown in FIG. 1 or the UE acting as UE-to-Network relay 520 shown in FIG. 5. The network node may be the base station 110 shown in FIG. 1, the gNB 530 shown in FIG. 5, or any entity implementing PCF (such as PCF 205 shown in FIG. 2).

Optionally or additionally, in step 610, the UE may store a UE route selection policy including a traffic descriptor to be used by the UE for D2D communication in a memory of the UE. In step 620, the UE may register, roam to another PLMN or request to provide the UE route selection policy. More specifically, the network node determines whether to provide a UE route selection policy to the UE (not shown in FIG. 6) in response, but not limited, to these examples of step 620. Also, the network node may determine that the UE route selection policy for the UE has changed and/or that a time interval to provide/update the UE route selection policy elapsed.

In step 630, the network (e.g., the PCF via the AMF and the gNB) provides the UE route selection policy including a traffic descriptor to be used by the UE for D2D communication to the UE. The traffic descriptor includes information indicating use for D2D communication. Examples of the UE route selection policy and the traffic descriptor to be used by the UE for D2D communication will be described later. The UE receives the UE route selection policy and stores the received the UE route selection policy as an initial configuration or update for a previously received or pre-stored UE route selection policy.

In step 640, the UE matches a request for D2D or tethering with the URSP information (received in step 630) indicating use for D2D communication to determine whether to select the UE route selection policy. Step 640 may be performed in response to a request to act as Network relay received by UE 520 from a remote UE 510 or in response to the start of a tethering process.

In step 650, the UE sets up a connection or connections to be used by the UE to support D2D and tethering communication. For example, the UE may set up the NR PC5 connection 515 with the remote UE 510 and/or the NR Uu connection 525 with the gNB 530 for the sake of relaying traffic between PC5 and the 5G Core. The UE may use parameters defined by the route selection descriptor associated with the traffic descriptor that includes the information associated with D2D and/or tethering. Examples of parameters includes, but are not limited to, S-NSSAI, DNN, a SSC mode, a PDU Session type, a path selection rule between direct and indirect ProSe communication over the NR PC5 connection, security credentials, and a parameter for the NR PC5 connection.

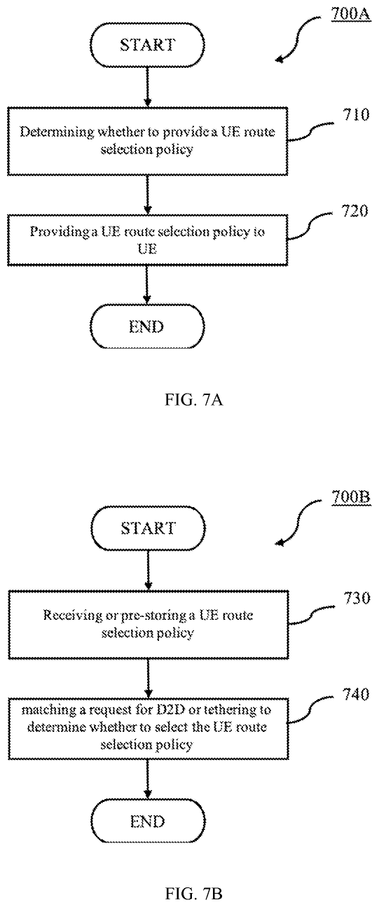

FIG. 7A illustrates a flow chart of a method of providing a UE route selection policy according to some embodiments. The method may be performed by a network node (such as the base station 110 shown in FIG. 1 or the PCF 205 shown in FIG. 2) of a wireless communication system (such as the wireless communication system 100 shown in FIG. 1 or the 5G system 200 shown in FIG. 2) supporting device-to-device (D2D) communication (e.g., ProSe or UE-to-Network relay).

In step 710, the network node 110 determines whether to provide the UE route selection policy to the UE 120. In some examples, the network node may determine that the UE 120 has registered to the wireless communication system 100 or that the UE 120 roams to another PLMN. In other examples, the network node 110 may determine that the UE route selection policy for the UE 120 has changed or that a time interval has elapsed. In order words, the network node may update the UE route selection policy in given time intervals. Also, the UE 120 may request the network node 110 to provide the UE route selection policy.

In step 720, the network node 110 provides the UE route selection policy including a traffic descriptor to be used by the UE for D2D communication to the UE 120 in response to determining in step 710. The traffic descriptor includes information indicating use for D2D communication. Examples of the UE route selection policy and the traffic descriptor to be used by the UE for D2D communication will be described later.

FIG. 7B illustrates a flow chart of a method of receiving a UE route selection policy according to some embodiments. The method may be performed by a UE (such as the UE 120 shown in FIG. 1 or the UE 201 shown in FIG. 2) of a wireless communication system (such as the wireless communication system 100 shown in FIG. 1 or the 5G system 200 shown in FIG. 2) supporting device-to-device (D2D) communication (e.g., ProSe or UE-to-Network relay).

In step 730, the UE 120 receives a UE route selection policy including a traffic descriptor to be used by the UE 120 for D2D communication from the network node 110. In other examples, additionally or optionally, the UE 120 may pre-store the UE route selection policy in a memory. The traffic descriptor includes information indicating use for D2D communication. Examples of the UE route selection policy and the traffic descriptor to be used by the UE for D2D communication will be described later.

The UE 120 may receive the UE route selection policy from the wireless communication system 100 via the network node 110 when the UE 120 has registered to the wireless communication system 100, when the UE 120 roams to another PLMN, and/or when the UE 120 requests the network node 110 to provide the UE route selection policy. Also, the UE 120 may receive the UE route selection policy from the network node 110 when the UE route selection policy has changed and/or when a time interval has elapsed.

In step 740, the UE matches a request for D2D or tethering with the URSP information (received in step 730) indicating use for D2D communication to determine whether to select the UE route selection policy. Step 740 may be performed in response to a request to act as Network relay received by UE 520 from a remote UE 510 or in response to the start of a tethering process. Having selected the UE route selection policy or traffic descriptor, the UE 120 may use the parameter included in the UE route selection policy or traffic descriptor to set up the NR PC5 connection 515 with the remote UE 510 and/or the NR Uu connection 525 with the gNB 530 for the sake of relaying traffic between PC5 and the 5G Core.

In this way, the UE 120 may act as UE-to-Network relay connecting the UE 120 to the wireless communication system 100 and relays traffic towards/from the wireless communication system 100 on behalf of the remote UE 510 which is connected to the UE 120 but cannot access to the wireless communication system 100. In other embodiments, the UE 120 performs tethering for the remote UE 510.

In some embodiments, as will be described in more detail below, the traffic descriptor comprises connection capabilities information indicating a capability of a connection to be used. The connection capabilities information may comprise a value representing the information indicating the use for D2D communication (e.g., “ProSe”, tethering, or the like). So, the value indicates ProSe (or tethering) as the capability of the connection to be used. In other embodiments, the traffic descriptor comprises tethering capabilities information representing the information indicating use for D2D communication. The tethering capabilities information comprises one or more values each indicating a tethering method to be used for D2D communication (e.g., ProSe, Bluetooth™, or the like).

In some embodiments, the UE route selection policy includes one or more route selection descriptors associated with the traffic descriptor that includes the information indicating the use for relaying D2D communication. The route selection descriptor defines parameters for setting up a connection to be used by the UE for relaying D2D communication. Exemplary parameters include: S-NSSAI, DNN, a SSC mode, a PDU Session type, a path selection rule between direct and indirect proximity-based service communication over a PC5 connection, security credentials, and a parameter for the PC5 connection of ProSe.

Regarding UE route selection policy information, reference is made to TS 23.503, incorporated herein by reference in its entirety. In clause 6.6.2 of TS 23.503, UE route selection policy information is specified. This UE route selection policy information is intended as data element that is maintained by PCF in the wireless communication network (e.g. 5G systems network) and is delivered to a UE to guide UE decisions especially with regard to parameters of PDU sessions that the UE requests from the network. When necessary, i.e. when a new UE has registered for the first time, when the UE roams to another PLMN or when the policy for a specific UE changes to name only some of the possibilities, then PCF updates the UE with the latest applicable policy in the present UE location.

The UE route selection policy allows the PCF to configure prioritized route selection policies that apply based on certain traffic descriptors as exemplified in Table 6.6.2.1-2 of TS 23.503. The traffic descriptors may include, among others, parameters such as operating system and application descriptor, IP descriptor and non-IP descriptors identifying target address, target DNN and connection capabilities.

When setting up connectivity over 3GPP or Non-3GPP, the UE matches the intended connectivity request with the traffic descriptors and identifies the highest priority UE route selection policy rule where the traffic descriptor matches with the intended communication parameters. Once the highest priority UE route selection policy rule that is valid has been identified, the UE uses the protocol parameters inside the associated list of route selection descriptors for setting up the desired connectivity. Route selection descriptor parameters are exemplified in Table 6.6.2.1-3 of TS 23.503, and include SSC mode, network slice identified by S-NSSAI, PDU Session type, Non-Seamless Offload indication, Access Type preference between 3GPP and Non-3GPP.

For example, the UE route selection policy that is specified in TS 23.503, clause 6.6.2, may be extended as described hereinbelow. The UE route selection policy may be extended to define specific policies for the case where the UE acts as a UE-to-Network relay, or for the case where the UE does tethering. As described above, the UE route selection policy may be extended to include a traffic descriptor to be used by the UE for D2D communication, wherein the traffic descriptor includes information indicating use for D2D communication.

In some examples, the traffic descriptor part (also referred to as traffic descriptor) may be extended to identify traffic descriptors that the UE should use for ProSe connectivity, e.g, but not limited to when acting as UE-to-Network relay or when supporting other forms of traffic tethering (such as when the UE relays traffic on behalf of another device such as a PC connected to a WiFi/WLAN AP (Access Point) hosted by the UE). The traffic descriptor part is applied by the UE when determining which traffic descriptor to use for determining the route selection descriptor parameters to apply for ProSe connectivity.

In some example, the route selection descriptor part (also referred to as route selection descriptor) may be extended to contain additional parameters that are needed for ProSe connectivity. The route selection descriptor part is an extension of the route selection descriptors in those cases when the list of route selection descriptors as described in TS 23.503 does not cover all ProSe communication parameters (such as credentials needed for setting up ProSe UE-to-Network connectivity over PC5 interface) needed.

An example of the traffic descriptor part is shown in Table 1. As shown in Table 1, the Connection Capabilities descriptor may have a new value indicating use for D2D communication. According to a non-limiting example, “ProSe” may be used as the new value (see NOTE 4 in Table 1).

TABLE 1
UE Route Selection Policy Rule according to one embodiment

| | | | PCF | |
|---|---|---|---|---|
| | | | permitted | |
| | | | to modify | |
| Information | | | in a UE | |
| name | Description | Category | context | Scope |
| Rule | Determines the order the | Mandatory | Yes | UE |
| Precedence | URSP rule is enforced in | (NOTE 1) | | context |
| | the UE. | | | |
| Traffic | This part defines the | Mandatory | | |
| descriptor | Traffic descriptor | (NOTE 3) | | |
| | components for the | | | |
| | URSP rule. | | | |
| Application | It consists of OSId and | Optional | Yes | UE |
| descriptors | OSAppId(s). (NOTE 2) | | | context |
| IP | Destination IP 3 tuple(s) | Optional | Yes | UE |
| descriptors | (IP address or IPv6 | | | context |
| (NOTE 5) | network prefix, port | | | |
| | number, protocol ID of | | | |
| | the protocol above IP). | | | |
| Domain | Destination FQDN(s) | Optional | Yes | UE |
| descriptors | | | | context |
| Non-IP | Descriptor(s) for | Optional | Yes | UE |
| descriptors | destination information | | | context |
| (NOTE 5) | of non-IP traffic | | | |
| DNN | This is matched against | Optional | Yes | UE |
| | the DNN information | | | context |
| | provided by the | | | |
| | application. | | | |
| Connection | This is matched against | Optional | Yes | UE |
| Capabilities | the information provided | | | context |
| | by a UE application | | | |
| | when it requests a | | | |
| | network connection with | | | |
| | certain capabilities. | | | |
| | (NOTE 4) | | | |
| List of | A list of Route Selection | Mandatory | | |
| Route | Descriptors. The | | | |
| Selection | components of a Route | | | |
| Descriptors | Selection Descriptor are | | | |
| | described in table | | | |
| | 6.6.2.1-3. | | | |

(NOTE 1):
Rules in a URSP shall have different precedence values.
(NOTE 2):
The information is used to identify the Application(s) that is(are) running on the UE’s OS. The OSId does not include an OS version number. The OSAppId does not include a version number for the application.
(NOTE 3):
At least one of the Traffic descriptor components shall be present.
(NOTE 4):
The format and some values of Connection Capabilities, e.g. “ims”, “mms”, “internet”, “ProSe” etc., are defined in TS 24.526. More than one connection capabilities value can be provided.
(NOTE 5):
A URSP rule cannot contain the combination of the Traffic descriptor components IP descriptors and Non-IP descriptors.

Another example of the traffic descriptor part is shown in Table 2. As shown in Table 2, The UE route selection policy rule may be extended by a new traffic descriptor (designated tethering capabilities) that can be used for any kind of tethering connectivity. The new traffic descriptor may be matched by the UE against the information related with the intended tethering method, including ProSe and Bluetooth™, but not limited to them.

TABLE 2
UE Route Selection Policy Rule according to one embodiment

| | | | PCF | |
|---|---|---|---|---|
| | | | permitted | |
| | | | to modify | |
| Information | | | in a UE | |
| name | Description | Category | context | Scope |
| Rule | Determines the order the | Mandatory | Yes | UE |
| Precedence | URSP rule is enforced in | (NOTE 1) | | context |
| | the UE. | | | |
| Traffic | This part defines the | Mandatory | | |
| descriptor | Traffic descriptor | (NOTE 3) | | |
| | components for the | | | |
| | URSP rule. | | | |
| Application | It consists of OSId and | Optional | Yes | UE |
| descriptors | OSAppId(s). (NOTE 2) | | | context |
| IP | Destination IP 3 tuple(s) | Optional | Yes | UE |
| descriptors | (IP address or IPv6 | | | context |
| (NOTE 5) | network prefix, port | | | |
| | number, protocol ID of | | | |
| | the protocol above IP). | | | |
| Domain | Destination FQDN(s) | Optional | Yes | UE |
| descriptors | | | | context |
| Non-IP | Descriptor(s) for | Optional | Yes | UE |
| descriptors | destination information | | | context |
| (NOTE 5) | of non-IP traffic | | | |
| DNN | This is matched against | Optional | Yes | UE |
| | the DNN information | | | context |
| | provided by the | | | |
| | application. | | | |
| Connection | This is matched against | Optional | Yes | UE |
| Capabilities | the information provided | | | context |
| | by a UE application | | | |
| | when it requests a | | | |
| | network connection with | | | |
| | certain capabilities. | | | |
| | (NOTE 4) | | | |
| Tethering | This is matched against | Optional | Yes | UE |
| capabilities | the information related | | | context |
| | with the intended | | | |
| | tethering method, | | | |
| | including ProSe and | | | |
| | Bluetooth, but not | | | |
| | limited to them | | | |
| List of | A list of Route Selection | Mandatory | | |
| Route | Descriptors. The | | | |
| Selection | components of a Route | | | |
| Descriptors | Selection Descriptor are | | | |
| | described in table | | | |
| | 6.6.2.1-3. | | | |

(NOTE 1):
Rules in a URSP shall have different precedence values.
(NOTE 2):
The information is used to identify the Application(s) that is(are) running on the UE’s OS. The OSId does not include an OS version number. The OSAppId does not include a version number for the application.
(NOTE 3):
At least one of the Traffic descriptor components shall be present.
(NOTE 4):
The format and some values of Connection Capabilities, e.g. “ims”, “mms”, “internet”, etc., are defined in TS 24.526. More than one connection capabilities value can be provided.
(NOTE 5):
A URSP rule cannot contain the combination of the Traffic descriptor components IP descriptors and Non-IP descriptors.

The traffic descriptor to be used by the UE for D2D communication may be encoded in two alternative ways, either as shown in Table 1 or Table 2. Irrespective of which way the traffic descriptor to be used by the UE for D2D communication is encoded, the UE evaluates also this new information when identifying the rule that matches. The associated list of route selection description parameters contains the parameters for ProSe or tethering connectivity establishment (e.g., S-NSSAI, DNN, path selection rule between direct communication and indirect ProSe communication over PC5, etc.).

An example of the route selection descriptor part is shown in Table 3. As shown in Table 3, the list of the route selection descriptor part may be extended so as to include tethering parameter indicating the route selection description parameters that are specific to tethering e.g. over ProSe PC5. The route selection description parameters may include security credentials, path selection preference etc. When the UE has identified the list of route selection descriptions that is associated with the applicable traffic descriptor, the UE uses the parameters inside that list of route selection description to set up connectivity, and the UE also uses the ProSe related parameters, such as DNN and S-NSSAI to be used for ProSe (that could differ from those that are used for the same application over direct 3GPP or Non-3GPP connection), and the tethering parameters that are specific to ProSe (and other) tethering case.

TABLE 3
Route Selection Descriptors according to one embodiment

| | | | PCF | |
|---|---|---|---|---|
| | | | permitted | |
| Information | | | to modify | |
| name | Description | Category | in URSP | Scope |
| Route | Determines the order in | Mandatory | Yes | UE |
| Selection | which the Route | (NOTE 1) | | context |
| Descriptor | Selection Descriptors are | | | |
| Precedence | to be applied. | | | |
| Route | This part defines the | Mandatory | | |
| selection | route selection | (NOTE 2) | | |
| components | components | | | |
| SSC Mode | One single value of SSC | Optional | Yes | UE |
| Selection | mode. | | | context |
| | (NOTE 5) | | | |
| Network | Either a single value or a | Optional | Yes | UE |
| Slice | list of values of S- | (NOTE 3) | | context |
| Selection | NSSAI(s). | | | |
| DNN | Either a single value or a | Optional | Yes | UE |
| Selection | list of values of DNN(s). | | | context |
| PDU Session | One single value of PDU | Optional | Yes | UE |
| Type | Session Type | (NOTE 8) | | context |
| Selection | | | | |
| Non- | Indicates if the traffic of | Optional | Yes | UE |
| Seamless | the matching application | (NOTE 4) | | context |
| Offload | is to be offloaded to non- | | | |
| indication | 3GPP access outside of | | | |
| | a PDU Session. | | | |
| Access Type | Indicates the preferred | Optional | Yes | UE |
| preference | Access Type (3GPP or | | | context |
| | non-3GPP or Multi- | | | |
| | Access) when the UE | | | |
| | establishes a PDU | | | |
| | Session for the matching | | | |
| | application. | | | |
| Tethering | Indicates the Route | Optional | Yes | UE |
| parameters | Selection Description | | | context |
| | parameters that are | | | |
| | specific to tethering e.g. | | | |
| | over ProSe PC5. These | | | |
| | include security | | | |
| | credentials, path | | | |
| | selection preference etc. | | | |
| Route | This part defines the | Optional | | |
| Selection | Route Validation | | | |
| Validation | Criteria components | | | |
| Criteria | | | | |
| (NOTE 6) | | | | |
| Time | The time window when | Optional | Yes | UE |
| Window | the matching traffic is | | | context |
| | allowed. The RSD is not | | | |
| | considered to be valid if | | | |
| | the current time is not in | | | |
| | the time window. | | | |
| Location | The UE location where | Optional | Yes | UE |
| Criteria | the matching traffic is | | | context |
| | allowed. The RSD rule is | | | |
| | not considered to be | | | |
| | valid if the UE location | | | |
| | does not match the | | | |
| | location criteria. | | | |

(NOTE 1):
Every Route Selection Descriptor in the list shall have a different precedence value.
(NOTE 2):
At least one of the route selection components shall be present.
(NOTE 3):
When the Subscription Information contains only one S-NSSAI in UDR, the PCF needs not provision the UE with S-NSSAI in the Network Slice Selection information. The “match all” URSP rule has one S-NSSAI at most.
(NOTE 4):
If this indication is present in a Route Selection Descriptor, no other components shall be included in the Route Selection Descriptor.
(NOTE 5):
The SSC Mode 3 shall only be used when the PDU Session Type is IP.
(NOTE 6): The Route Selection Descriptor is not considered valid unless all the provided Validation Criteria are met.
(NOTE 7):
In this Release of specification, inclusion of the Validation Criteria in Roaming scenarios is not considered.
(NOTE 8):
When the PDU Session Type is “Ethernet” or “Unstructured”, this component shall be present.

The subject-matter described herein may be embodied in systems, apparatus, methods, and/or articles depending on the desired configuration. For example, the user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and sub-combinations of the disclosed features and/or combinations and sub-combinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least”. The use of the phase “such as” means “such as for example” unless otherwise indicated.

1. A network node in a wireless communication system supporting device-to-device (D2D) communication, comprising:
at least one processor; and
at least one memory including computer program code, wherein the computer program code causes the network node, when executed with the at least one processor, to at least:
provide, to a user equipment (UE) in the wireless communication system, a UE route selection policy including a traffic descriptor to be used by the UE for relaying D2D communication, the traffic descriptor including a parameter to be used by the UE to set up at least one of the following: a PC5 connection or a Uu connection.

2. The network node of claim 1, wherein the traffic descriptor comprises connection capabilities information indicating a capability of a connection to be used, the connection capabilities information comprising a value representing the information indicating the use for relaying D2D communication.

3. The network node of claim 2, wherein the value indicating a proximity-based service of the wireless communication system as the capability of the connection to be used.

4. The network node of claim 1, wherein the traffic descriptor comprises tethering capabilities information representing the information indicating use for relaying D2D communication, the tethering capabilities information comprising one or more values each indicating a tethering method to be used for relaying D2D communication.

5. The network node of claim 4, wherein the one or more values comprises a value to indicate a proximity-based service of the wireless communication system as the tethering method and a value to indicate Bluetooth as the tethering method.

6. The network node of claim 1, wherein the UE route selection policy further includes one or more route selection descriptors associated with the traffic descriptor that includes the information indicating the use for relaying D2D communication, each route selection descriptor defining parameters for setting up a connection to be used by the UE for relaying D2D communication.

7. The network node of claim 6, wherein the parameters include one or more of: Single Network Slice Selection Assistance Information (S-NSSAI), Data Network Name (DNN), a path selection rule between direct and indirect proximity-based service communication over the PC5 connection, security credentials, and a parameter for the PC5 connection of a proximity-based service of the wireless communication system.

8. The network node of claim 1, wherein the computer program code causes the network node, when executed with the at least one processor, to provide the UE route selection policy in response to determining one of the following: the UE has registered to the wireless communication system, the UE roams to another Public Land Mobile Network (PLMN), the UE route selection policy for the UE has changed, the UE requests to provide the UE route selection policy, and a time interval elapsed.

9. The network node of claim 1, wherein the UE is acting as a UE-to-Network relay connecting the UE to the wireless communication system and relaying traffic towards/from the wireless communication system on behalf of a remote UE, or the UE performs tethering for the remote UE, wherein the remote UE is connected to the UE but cannot access to the wireless communication system.

10. The network node of claim 1, wherein the wireless communication system is a 5G system and the D2D communication is a proximity-based service.

11. A user equipment (UE) in a wireless communication system supporting device-to-device (D2D) communication, comprising:
at least one processor; and
at least one memory including computer program code, wherein the computer program code causes the UE, when executed with the at least one processor, to at least:
receive, from a network node in the wireless communication system, or store in the at least one memory a UE route selection policy including a traffic descriptor; and
relay D2D communication, wherein the traffic descriptor is used by the UE for relaying D2D communication, the traffic descriptor including a parameter to be used by the UE to set up at least one of the following: a PC5 connection or a Uu connection.

12. The UE of claim 11, wherein the traffic descriptor comprises connection capabilities information indicating a capability of a connection to be used, the connection capabilities information comprising a value representing the information indicating the use for relaying D2D communication.

13. The UE of claim 12, wherein the value indicating a proximity-based service of the wireless communication system as the capability of the connection to be used.

14. The UE of claim 11, wherein the traffic descriptor comprises tethering capabilities information representing the information indicating use for relaying D2D communication, the tethering capabilities information comprising one or more values each indicating a tethering method to be used for relaying D2D communication.

15. The UE of claim 14, wherein the one or more values comprises a value to indicate a proximity-based service of the wireless communication system as the tethering method and a value to indicate Bluetooth as the tethering method.

16. The UE of claim 11, wherein the UE route selection policy further includes one or more route selection descriptors associated with the traffic descriptor that includes the information indicating the use for relaying D2D communication, each route selection descriptor defining parameters for setting up a connection to be used by the UE for relaying D2D communication.

17. The UE of claim 16, wherein the parameters include one or more of: Single Network Slice Selection Assistance Information (S-NSSAI), Data Network Name (DNN), a path selection rule between direct and indirect proximity-based service communication over the PC5 connection, security credentials, and a parameter for the PC5 connection of a proximity-based service of the wireless communication system.

18. The UE of claim 11, wherein the computer program code further causes the UE, when executed with the at least one processor, to match a request for D2D or tethering with the information indicating use for relaying D2D communication to determine whether to select the UE route selection policy.

19. The UE of claim 11, wherein the UE is acting as a UE-to-Network relay connecting the UE to the wireless communication system and relaying traffic towards/from the wireless communication system on behalf of a remote UE, or the UE performs tethering for the remote UE, wherein the remote UE is connected to the UE but cannot access to the wireless communication system.

20. The UE of claim 11, wherein the wireless communication system is a 5G system and the D2D communication is a proximity-based service.

21. A method in a network node of a wireless communication system supporting device-to-device (D2D) communication, the method comprising:
providing, to a user equipment (UE) in the wireless communication system, a UE route selection policy including a traffic descriptor to be used by the UE for relaying D2D communication, the traffic descriptor a parameter to be used by the UE to set up at least one of the following: a PC5 connection or a Uu connection.

22. A method in a user equipment (UE) of a wireless communication system supporting device-to-device (D2D) communication, the method comprising:
receiving, from a network node in the wireless communication system, or storing in at least one memory of the UE, a UE route selection policy including a traffic descriptor; and
relaying D2D communication, wherein the traffic descriptor is used by the UE for relaying D2D communication, the traffic descriptor including a parameter to be used by the UE to set up at least one of the following: a PC5 connection or a Uu connection.

23. A computer program product comprising program instructions stored on a non-transitory computer readable medium to execute the method of claim 21 when said program is executed on a computer.

24. A computer program product comprising program instructions stored on a non-transitory computer readable medium to execute the method of claim 22 when said program is executed on a computer.
